(19) United States
(12) Patent Application Publication
(10) Pub. No.: US 2026/0116041 A1
(43) Pub. Date: Apr. 30, 2026

(54) HEAT RADIATION COMPOSITE FILM

(71) Applicant: SHIN-ETSU CHEMICAL CO., LTD., Tokyo (JP)

(72) Inventors: Keiji IMAIZUMI, Takasaki-shi (JP); Akihiro ENDO, Annaka-shi (JP)

(73) Assignee: SHIN-ETSU CHEMICAL CO., LTD., Tokyo (JP)

(21) Appl. No.: 19/118,823

(22) PCT Filed: Aug. 31, 2023
(86) PCT No.: PCT/JP2023/031732

§ 371 Date: Apr. 7, 2025

(30) Foreign Application Priority Data
Oct. 19, 2022 (JP) 2022-167531

(51) Int. Cl. B32B 7/027; B32B 7/12; B32B 15/08; C09J 7/24; C09J 7/29; C09J 7/30

(52) U.S. Cl. CPC B32B 7/027; B32B 7/12; B32B 15/08; C09J 7/24; C09J 7/29; C09J 7/30; B32B 2250/02; B32B 2307/302; B32B 2307/7376; C09J 2400/163; C09J 2433/006; C09J 2483/00

(57) ABSTRACT

A heat radiation composite film including: a heat radiation layer; and an adhesion layer, wherein the heat radiation layer has a thickness of 5 μm or more and 200 μm or less, and one surface of the heat radiation layer is a rough surface having an emissivity of 0.80 or more and having a developed area ratio of 1.5 or more, and the adhesion layer is provided on a side of a surface of the heat radiation layer opposite to the rough surface. This can provide a heat radiation composite film that can effectively lower temperature of a heat source.

### TECHNICAL FIELD

The present invention relates to a heat radiation composite film.

### BACKGROUND ART

In electronic devices, etc., a heat sink using a plate of a metal, such as aluminum or copper, with high thermal conductivity is conventionally employed in order to suppress rise in temperature of chips during operation. Such a heat sink conducts heat generated from the chips and dissipates the heat from its surface by virtue of temperature difference from the ambient air.

However, cases where the heat sink cannot be mounted have increased due to miniaturization, thinning, and higher performance of devices. For example, smartphones, digital video cameras, LED illuminations, etc. require heat dissipation countermeasure without the heat sink due to size and weight.

Under the circumstances, some parts for heat dissipation countermeasure utilizing heat radiation have been reported.

Patent Document 1 proposes a part in which a layer having high emissivity is provided on one surface of a thermal conductive layer with good in-plane thermal conductivity, an adhesion layer with low thermal resistance is provided on the other surface, and the part is adhered to a heat source to be easily provided for a gap where the heat sink cannot be mounted. In Patent Document 1, however, the emissivity of the heat radiation layer is regulated to 0.8 or more, but the emissivity is 1.0 in maximum. The part is insufficient as the heat dissipation countermeasure required in recent years.

Patent Document 2 proposes a method of dissipating heat from a heat generator as radiant heat by molding a ceramic material being calcined cordierite granules for using substitution of the heat sink or a substrate. This method, however, has problems of difficulty in molding due to high rigidity of the ceramic material and usability only on a flat surface of the heat-generative part.

In addition, proposed is a method in which a curable resin composition containing particles with high thermal emissivity is diluted with an appropriate organic solvent to prepare a paint, called a heat radiation paint, and this paint is applied or sprayed on a heat generator, and dried and cured for directly laminating a heat radiation layer on the heat generator to dissipate heat from the heat generator outside the system (for example, Patent Documents 3 and 4). However, the applying or spraying on the heat generator requires introduction of equipment therefor, causes difficulty in management of an applying amount or a spraying amount, and requires a step for curing the paint, etc., leading to a disadvantage of a complex process.

Patent Document 5 proposes a heat radiation sheet in which a heat radiation film is formed on one surface of a thin metal plate, and an adhesion layer is adhered onto the other surface of the thin metal plate. However, according to Examples of Patent Document 5, a thickness of the adhesion layer is extremely thick of about 180 μm, which inhibits flow of the heat.

### CITATION LIST

### Patent Literature

Patent Document 1: JP 2017-208458 A
Patent Document 2: JP 2006-298703 A
Patent Document 3: JP 2004-43612 A
Patent Document 4: JP 2013-144747 A
Patent Document 5: JP 2004-200199 A

### SUMMARY OF INVENTION

### Technical Problem

The present invention has been made in view of the above circumstances. An object of the present invention is to provide a heat radiation composite film that can effectively lower temperature of a heat source.

### Solution to Problem

To solve the above problems, the present invention provides a heat radiation composite film including:
a heat radiation layer; and
an adhesion layer,
wherein the heat radiation layer has a thickness of 5 μm or more and 200 μm or less, and one surface of the heat radiation layer is a rough surface having an emissivity of 0.80 or more and having a developed area ratio of 1.5 or more, and
the adhesion layer is provided on a side of a surface of the heat radiation layer opposite to the rough surface.

Such a heat radiation composite film can effectively lower temperature of a heat source or a temperature inside a housing. In addition, the heat radiation composite film of the present invention has the adhesion layer and the film shape, and is therefore easily provided on the heat source or the housing.

The heat radiation layer preferably includes any one selected from the group consisting of a polyester resin, a fluororesin, an acrylic resin, an epoxy resin, a urethane resin, and a polyolefin resin.

The heat radiation composite film using the heat radiation layer containing such a material can exhibit sufficient flexibility.

The heat radiation composite film preferably further includes one or more of a substrate layer between the heat radiation layer and the adhesion layer, wherein the substrate layer includes any one or more selected from the group consisting of a polyester resin, a fluororesin, an acrylic resin, an epoxy resin, a urethane resin, a polyolefin resin, a silicone resin, and a metal foil.

Such a substrate layer can sufficiently achieve adhesion to the heat radiation layer to increase strength of the heat radiation composite film.

In this case, a total thickness of the heat radiation layer and the substrate layer is more preferably 30 μm or more and 200 μm or less, and a ratio of a thickness of the heat radiation layer to a thickness of the substrate layer is more preferably 0.02 or more and 39 or less.

The heat radiation composite film including the heat radiation layer and the substrate layer with such a relationship can exhibit more excellent balance between excellent heat radiation ability and high strength. The substrate layer is preferably a metal foil having a thermal conductivity in a plane direction of 200 W/mK or more.

The heat radiation composite film including such a substrate layer as above can efficiently conduct heat from a heat source to the heat radiation layer.

The adhesion layer preferably has a thermal resistance of 1.2 cm²·K/W or less.

The heat radiation composite film including such an adhesion layer can more efficiently conduct heat from a heat source to the heat radiation layer.

The adhesion layer may include a thermal conductive filler.

The heat radiation composite film including such an adhesion layer can more efficiently conduct heat from a heat source to the heat radiation layer.

For example, the adhesion layer may be a cured product of a silicone composition including essential components of:
(a) 100 parts by mass of a linear organopolysiloxane having an alkenyl group;
(b) 300 to 900 parts by mass of a thermal conductive filler;
(c) an organohydrogenpolysiloxane at an amount so that a mole ratio of a hydrogen atom directly bonded to a silicon atom in the component (c) relative to the alkenyl group in the component (a) is 0.5 to 20; and
(d) a platinum-group metallic catalyst at 0.1 to 1,000 ppm of the component (a) in terms of a mass of a platinum-group metal element.

The heat radiation composite film including such an adhesion layer can have good adhesiveness and, in addition, more efficiently conduct heat from a heat source to the heat radiation layer.

In this case, the silicone composition preferably further includes: (e) 50 to 300 parts by mass of a silicone resin having a branched chain structure.

Such a component (e) can impart a cohesive property to the adhesive in the adhesion layer.

### Advantageous Effects of Invention

As described above, the heat radiation composite film of the present invention can effectively lower temperature of a heat source or temperature inside a housing. In addition, the heat radiation composite film of the present invention has the adhesion layer and the film shape, and therefore can be easily provided on the heat source or the housing.

### BRIEF DESCRIPTION OF DRAWINGS

FIG. 1 is a schematic sectional view illustrating an example of a heat radiation composite film of the present invention; and

FIG. 2 is a schematic sectional view illustrating another example of a heat radiation composite film of the present invention.

### DESCRIPTION OF EMBODIMENTS

As described above, there has been a demand for development of a heat radiation composite film that can effectively lower temperature of a heat source.

The present inventors have earnestly studied the above objects, and consequently found that temperature of a heat source or temperature inside a housing can be effectively lowered by virtue of a heat radiation composite film in which a heat radiation layer has a thickness of 5 μm or more and 200 μm or less, one surface of the heat radiation layer is a rough surface having an emissivity of 0.80 or more and having a developed area ratio of 1.5 or more, and the adhesion layer is provided on a side of a surface of the heat radiation layer opposite to the rough surface. Based on this finding, the present inventor completed the present invention.

Specifically, the present invention is a heat radiation composite film including:
a heat radiation layer; and
an adhesion layer,
wherein the heat radiation layer has a thickness of 5 μm or more and 200 μm or less, and one surface of the heat radiation layer is a rough surface having an emissivity of 0.80 or more and having a developed area ratio of 1.5 or more, and
the adhesion layer is provided on a side of a surface of the heat radiation layer opposite to the rough surface.

Hereinafter, the present invention will be described in detail, but the present invention is not limited thereto.

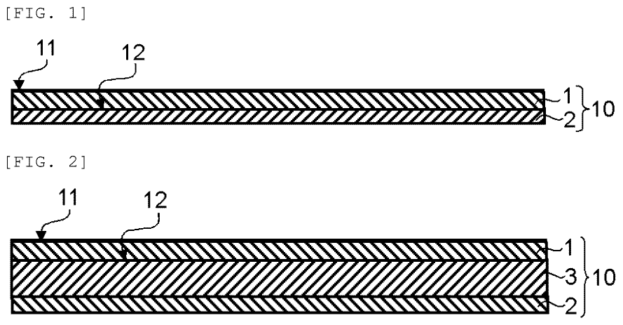

FIG. 1 is a schematic sectional view illustrating an example of a heat radiation composite film of the present invention.

A heat radiation composite film 10 in FIG. 1 has a heat radiation layer 1 and an adhesion layer 2. One surface 11 of the heat radiation layer 1 is a rough surface. The adhesion layer 2 is provided on a side of a surface 12 of the heat radiation layer 1 opposite to the rough surface 11.

As illustrated in FIG. 1, the adhesion layer 2 may be directly provided on the surface 12 of the heat radiation layer 1 opposite to the rough surface 11. Alternatively, as illustrated in FIG. 2, a substrate layer 3 may be provided on the opposite surface 12 of the heat radiation layer 1, and the adhesion layer 2 may be provided on this substrate layer 3. A number of the substrate layer 3 may be one or more. That is, the heat radiation composite film 10 of the present invention may further have one or more of the substrate layers 3 between the heat radiation layer 1 and the adhesion layer 2.

Hereinafter, each component of the heat radiation composite film of the present invention will be described in more detail.

### [Heat Radiation Layer]

In the heat radiation composite film 10 of the present invention, the heat radiation layer 1 is characterized to have a thickness of 5 μm or more and 200 μm or less, and preferably 10 μm or more and 100 μm or less. With the thickness of less than 5 μm, it is extremely difficult to prepare the one surface 11 to be the rough surface having a developed area ratio of 1.5 or more. With the thickness of more than 200 μm, heat conduction efficiency inside the heat radiation composite film 10 deteriorates.

Furthermore, an emissivity of the surface of the heat radiation layer 1 is characterized to be 0.80 or more, and preferably 0.83 to 0.99. With the emissivity of less than 0.80, the sufficient effect of heat dissipation cannot be obtained. It should be noted that the emissivity in the present invention is a value measured by using a thermal emissivity meter (TSS-5X-2, available from JAPANSENSOR CORPORATION).

Further, the one surface 11 of the heat radiation layer 1 is characterized to be the rough surface having a developed area ratio of 1.5 or more, more preferably 1.7 or more. With the developed area ratio of less than 1.5, the sufficient effect cannot be obtained. An upper limit of the developed area ratio is not particularly limited, and may be 4.0, for example. It should be noted that the developed area ratio in the present invention is a ratio of a surface area/an area, and is a value calculated by measuring a measurement area of the film surface and a surface area of this measurement area with a digital microscope (VHX-6000, available from KEYENCE CORPORATION).

The heat radiation composite film 10 of the present invention in which such a heat radiation layer 1 is included and the adhesion layer 2 is provided on a side of the surface 12 of the heat radiation layer 1 opposite to the rough surface 11 can efficiently dissipate heat from the heat source or the housing by adhering it to a heat source or a housing containing a heat source, and consequently, can effectively lower temperature of the heat source or temperature inside the housing. That is, the heat radiation composite film 10 of the present invention is extremely useful for effectively lowering temperature of a heat source.

### [Material of Heat Radiation Layer]

A material of the heat radiation layer 1 is not particularly limited as long as the thermal emissivity is achieved to be 0.80 or more. Specifically, the heat radiation layer 1 preferably includes any one selected from the group consisting of a polyester resin, a fluororesin, an acrylic resin, an epoxy resin, a urethane resin, and an olefin resin. The heat radiation layer 1 containing such a material can exhibit sufficient flexibility. For a purpose of improving the thermal emissivity, the heat radiation layer 1 may contain particles having high thermal emissivity, such as ceramic powders such as silica, alumina, titanium oxide, and boron nitride, cordierite powder, and graphite.

### [Substrate Layer]

In the heat radiation composite film 10 of the present invention, the substrate layer 3 is an optional component. The heat radiation composite film 10 including the substrate layer 3 as in FIG. 2 can exhibit higher strength.

### [Material of Substrate Layer]

A material of the substrate layer 3 is not particularly limited, but preferably a material that can achieve adhesion to the heat radiation layer 1. Specific examples of the material include resins same as for the heat radiation layer 1. The material is preferably a polyester resin, a fluororesin, an acrylic resin, an epoxy resin, a urethane resin, an olefin resin, a silicone resin, or a metal foil, and more preferably a metal foil having a thermal conductivity in a plane direction of 200 W/mK or more. With such a material, the substrate layer 3 can quickly diffuse heat from a heat generator in the plane direction when the area of the heat radiation composite film 10 can be practically larger than that of the heat generator. Accordingly, heat can be efficiently conducted to the heat radiation layer 1, and thus an advantage of increasing the area of the heat radiation composite film 10 can be utilized. The higher thermal conductivity of the substrate layer 3 in the plane direction is more preferable, but the thermal conductivity is actually 1,000 W/mK or less, for example.

It should be noted that the thermal conductivity of the substrate layer 3 in the present invention is a value calculated from the thermal diffusivity measured by using Thermo Wave Analyzer TA33/35, available from Bethel Co., Ltd.

### [Thickness of Substrate Layer]

A thickness of the substrate layer 3 is not particularly limited. A total thickness of the heat radiation layer 1 and the substrate layer 3 is preferably 30 μm or more and 200 μm or less, and more preferably 50 μm or more and 100 μm or less. A ratio of a thickness of the heat radiation layer 1 to the thickness of the substrate layer 3 is preferably 0.02 or more and 39 or less, and more preferably 0.2 or more and 19 or less. The heat radiation composite film including the heat radiation layer 1 and the substrate layer 3 with such a relationship can exhibit more excellent balance between excellent heat radiation ability and high strength.

### [Adhesion Layer]

The heat radiation composite film 10 of the present invention includes the adhesion layer 2, and thereby can be easily provided on a heat source or a housing.

### [Material of Adhesion Layer]

A material of the adhesion layer 2 is not particularly limited, and examples thereof include organic resin polymer matrixes such as an acrylic resin, a silicone resin, a urethane resin, and an epoxy resin. A thermal conductive filler may be added into the organic polymer matrix. The adhesion layer preferably has a thermal resistance of 1.2 cm²·K/W or less. The heat radiation composite film 10 including such an adhesion layer 2 can more efficiently conduct heat from a heat generator to the heat radiation layer 1. The lower thermal resistance of the adhesion layer is more preferable, but the thermal resistance is actually 0.1 cm²·K/W or more, for example.

Examples of the material of the adhesion layer 2 further preferably include a cured product of a silicone composition including essential components of:
(a) 100 parts by mass of an organopolysiloxane having an alkenyl group;
(b) 300 to 900 parts by mass of a thermal conductive filler;
(c) an organohydrogenpolysiloxane at an amount so that a mole ratio of a hydrogen atom directly bonded to a silicon atom in the component (c) relative to the alkenyl group in the component (a) is 0.5 to 20; and
(d) a platinum-group metallic catalyst at 0.1 to 1,000 ppm of the component (a) in terms of a mass of a platinum-group metal element.

Hereinafter, each component will be described in detail.

### [(a) Organopolysiloxane Having Alkenyl Group]

The organopolysiloxane having an alkenyl group, which is the component (a) of the adhesion layer 2, is a main component of the silicone polymer matrix.

The component (a) can be an organopolysiloxane having at least one, preferably two or more, alkenyl group(s) bonded to a silicon atom in one molecule. A main chain portion in the typical component (a) is basically composed of repetition of a diorganosiloxane unit, but may contain a branched structure in a part of the molecular structure, or may be a cyclic form. In terms of physical properties, such as mechanical strength, of the cured product, a linear diorganopolysiloxane is particularly preferable. A kinematic viscosity of the organopolysiloxane at 25° C. is favorably 100 to 50,000 mm²/s, and preferably 1,000 to 30,000 mm²/s. The kinematic viscosity is a value measured with a Cannon-Fenske viscosimeter described in JIS Z8803:2011.

The alkenyl group preferably has 2 to 8 carbon atoms, and examples thereof include a vinyl group, an allyl group, a propenyl group, an isopropenyl group, a butenyl group, a hexenyl group, and a cyclohexenyl group. Among these, a lower alkenyl group such as a vinyl group and an allyl group is preferable, and a vinyl group is particularly preferable.

A substituent, other than the alkenyl group, bonded to a silicon atom may be any monovalent hydrocarbon group bonded to a silicon atom of a common alkenyl-group-containing organopolysiloxane. The substituent is a monovalent hydrocarbon group having preferably 1 to 10 carbon atoms, more preferably 1 to 6 carbon atoms, and further preferably 1 to 3 carbon atoms. Specific examples thereof include: alkyl groups such as a methyl group, an ethyl group, a propyl group, an isopropyl group, a butyl group, an isobutyl group, a tert-butyl group, a pentyl group, a neopentyl group, a hexyl group, a heptyl group, an octyl group, a nonyl group, a decyl group, and a dodecyl group; cycloalkyl groups such as a cyclopentyl group, a cyclohexyl group, and a cycloheptyl group; aryl groups such as a tolyl group, a xylyl group, a naphthyl group, and a biphenylyl group; and aralkyl groups such as a benzyl group, a phenylethyl group, a phenylpropyl group, and a methylbenzyl group. Examples thereof further include a group in which a part or all hydrogen atoms bonded to a carbon atom in these groups are substituted with a halogen atom such as fluorine, for example, a 3,3,3-trifluoropropyl group and 3,3,4,4,5,5,6,6,6-nonafluorohexyl group. A methyl group, an ethyl group, a propyl group, and a 3,3,3-trifluoropropyl group are particularly preferable. The functional groups, other than the alkenyl group, bonded to a silicon atom are not limited to be all the same.

### [(b) Thermal Conductive Filler]

The thermal conductive filler blended in the adhesion layer 2 is not particularly limited, and a substance commonly employed as the thermal conductive filler, such as metals such as copper and aluminum, metal oxides such as alumina, silica, and magnesia, and metal nitrides such as aluminum nitride and boron nitride, may be used. One type of the thermal conductive filler may be used, or combination of two or more thereof may be used. In particular, the heat radiation composite film requires to have insulability, and thereby metal oxides, aluminum nitride, boron nitride, etc. are preferable, and alumina is more preferable.

A blending amount of the thermal conductive filler is 300 to 900 parts by mass, and preferably 400 to 750 parts by mass relative to 100 parts by mass of the component (a).

### [(c) Organohydrogenpolysiloxane]

The component (c) is the organohydrogenpolysiloxane, and the organohydrogenpolysiloxane favorably has 2 or more, preferably 2 to 100, of hydrogen atoms directly bonded to a silicon atom (hydrosilyl groups) in average in one molecule. The component (c) functions as a crosslinking agent for the component (a). A hydrosilylation reaction between the hydrosilyl group in the component (c) and the alkenyl group in the component (a) provides a three-dimensional network structure having a crosslinked structure. If the number of hydrosilyl groups is less than one in average, the curing may fail. The organohydrogenpolysiloxane may be a conventionally known compound, and may be any one of linear, branched, and cyclic compounds.

Examples of a substituent, other than the hydrogen atom, bonded to the organohydrogenpolysiloxane include groups same as the groups exemplified as the substituent other than the alkenyl group in the component (a).

A blending amount of the organohydrogenpolysiloxane is an amount so that a mole ratio of a hydrogen atom directly bonded to a silicon atom (a hydrosilyl group) in the component (c) relative to the alkenyl group in the component (a) is 0.5 to 20, preferably 1.0 to 10.

### [(d) Platinum-Group Metallic Catalyst]

The component (d) is a platinum-group metallic catalyst. The component (d) is any catalyst that enhances the addition reaction between the alkenyl group derived from the component (a) and the hydrosilyl group derived from the component (c), and examples thereof include catalysts known as a catalyst used for the hydrosilylation reaction. The component (d) is a platinum-type metal catalyst, for example. Examples thereof include: platinum-group metal single substances such as platinum (including platinum black), rhodium, and palladium; platinum chlorides, chloroplatinic acids, and chloroplatinate salts such as H₂PtCl₄·nH₂O, H₂PtCl₆·nH₂O, NaHPtCl₆·nH₂O, KaHPtCl₆·nH₂O, Na₂PtCl₆·nH₂O, K₂PtCl₄·nH₂O, PtCl₄·nH₂O, PtCl₂, and Na₂HPtCl₄·nH₂O, wherein “n” represents an integer of 0 to 6, preferably 0 or 6; an alcohol-modified chloroplatinic acid (see specification of U.S. Pat. No. 3,220,972 A); a complex between chloroplatinic acid and an olefin (see specification of U.S. Pat. No. 3,159,601 A, specification of U.S. Pat. No. 3,159,662 A, and specification of U.S. Pat. No. 3,775,452 A); materials in which a platinum-group metal such as platinum black and palladium is supported on a support such as alumina, silica, and carbon; and rhodium-olefin complex, chlorotris(triphenylphosphine) rhodium (Wilkinson catalyst), and a complex between platinum chloride, chloroplatinic acid, or a chloroplatinate salt and a vinyl-group-containing siloxane, specifically a vinyl-group-containing cyclic siloxane.

An amount of the component (d) is 0.1 to 1,000 ppm, and preferably 250 to 750 ppm in terms of a mass of a platinum-group metal element.

### [(e) Silicone Resin Having Branched Chain Structure]

The silicone composition (the adhesive) preferably contains a silicone resin having a branched chain structure as a component (e) in addition to the components (a) to (d).

The component (e) can impart a cohesive property to the adhesive. The component (e) has a branched chain structure, and is preferably a copolymer of a R₃SiO_{1/2} unit (an M unit) and a SiO_{4/2} unit (a Q unit).

Examples of a substituent bonded to the silicone resin having a branched chain structure include groups same as the groups exemplified as the substituent other than the alkenyl group in the component (a).

A blending amount of the component (e) if blended is preferably 50 to 300 parts by mass, and more preferably 100 to 250 parts by mass relative to 100 parts by mass of the component (a).

### [Thickness of Adhesion Layer]

A thickness of the adhesion layer 2 is not particularly limited, but a thermal resistance of the adhesion layer 2 alone is preferably 1.2 cm²·K/W or less. The thickness of the adhesion layer 2 is preferably 10 μm or more and 100 μm or less, and more preferably 10 μm or more and 80 μm or less. The thickness of the adhesion layer 2 of 10 μm or more and 100 μm or less can sufficiently prevent mixing of air while adhering to a heat generator, and does not inhibit the flow of heat from the heat generator.

### [Method for Producing Heat Radiation Composite Film]

The heat radiation layer 1 in the heat radiation composite film 10 of the present invention can be prepared by: a method of roughening the surface by a press-transferring method; a method of laminating the heat radiation layer 1 on the substrate layer 3 by a coating method, etc., and then roughening the one surface 11 of the heat radiation layer 1 by a sand-blast method; etc., but the method for preparing the heat radiation layer 1 is not limited thereto. Examples of a method for laminating the adhesion layer 2 on the side of the opposite surface 12 of the heat radiation layer 1 or on the side of the surface of the substrate layer 3 opposite to the heat radiation layer 1 include a coating method and an adhering method, but the method is not limited thereto.

### EXAMPLES

Hereinafter, the present invention will be specifically described by using Examples and Comparative Examples, but the present invention is not limited thereto.

### Examples 1 to 4 and Comparative Examples 1 to 4

A method for producing each of heat radiation composite films of Examples and Comparative Examples will be described below. Table 1 shows the structure of each of the heat radiation composite films of Examples and Comparative Examples.

### [Heat Radiation Layer and Substrate Layer]

### A-1

Heat radiation layer: An acrylic resin (heat-dissipating paint available from Pelnox, Ltd., trade name: Pelcool, thickness: 50 μm, emissivity, 0.86, developed area ratio: 1.7, thermal conductivity in plane direction: 0.1 W/mK)

Substrate layer: None

The above heat-dissipating paint was applied by using a comma coater so that the thickness was as above on a separator on which a silicone-resin releasing agent has been applied, and heated for curing at 80° C. for 10 minutes and then 120° C. for 10 minutes. Thereafter, the surface of the cured film was subjected to sand-blast processing, and released from the separator to obtain the heat radiation layer.

### A-2

Heat radiation layer: An acrylic resin) heat-dissipating paint available from Pelnox, Ltd., trade name: Pelcool, thickness: 30 μm, emissivity, 0.86, developed area ratio: 1.7, thermal conductivity in plane direction: 0.1 W/mK)

Substrate layer: Aluminum foil with 20 μm (thermal conductivity in plane direction: 236 w/mK)

The above heat-dissipating paint was applied on the aluminum foil by using a comma coater so that the thickness was as above, and heated for curing at 80° C. for 10 minutes and then 120° C. for 10 minutes. Thereafter, the surface of the cured film was subjected to sand-blast processing to obtain the substrate layer and the heat radiation layer formed on this substrate layer.

### A-3

Heat radiation layer: An acrylic resin (heat-dissipating paint available from Pelnox, Ltd., trade name: Pelcool, thickness: 30 μm, emissivity, 0.86, developed area ratio: 1.2, thermal conductivity in plane direction: 0.1 W/mK)

Substrate layer: Aluminum foil with 20 μm (thermal conductivity in plane direction: 236 w/mK)

The above heat-dissipating paint was applied on the aluminum foil by using a comma coater so that the thickness was as above, and heated for curing at 80° C. for 10 minutes and then 120° C. for 10 minutes. Thereafter, the surface of the cured film was subjected to hairline processing to obtain the substrate layer and the heat radiation layer formed on this substrate layer.

A-4 dissipating paint available from Pelnox, Ltd., trade name: Pelcool, thickness: 30 μm, emissivity, 0.86, developed area ratio: 1.0, thermal conductivity in plane direction: 0.1 W/mK)
Substrate layer: Aluminum foil with 20 μm (thermal conductivity in plane direction: 236 w/mK)

The above heat radiation layer was obtained by applying the heat-dissipating paint on the aluminum foil by using a comma coater so that the thickness was as above, and heating for curing the paint at 80° C. for 10 minutes and then 120° C. for 10 minutes. That is, the heat radiation layer A-4 had no rough surface.

### [Adhesion Layer]

### B-1

Silicone adhesive: 50 μm (thermal resistance: 2.8 cm²·K/W)

The above adhesion layer was obtained by applying an addition-reaction-type silicone adhesive available from Shin-Etsu Chemical Co. Ltd. by using a comma coater so that the thickness was as above on a separator on which a fluorine-modified silicone resin releasing agent has been applied, and heating for curing the adhesive at 80° C. for 3 minutes and then 120° C. for 5 minutes.

### B-2

Silicone adhesive: 50 μm (thermal resistance: 0.9 cm²·K/W)

The above silicone adhesive was a silicone composition composed of the following components (a) to (g), and prepared by mixing the components at the blending amounts by using a planetary mixer at 25° C. for 60 minutes.

Component (a): An organopolysiloxane having a kinematic viscosity at 25° C. of 30,000 mm²/s, represented by the following formula (1)

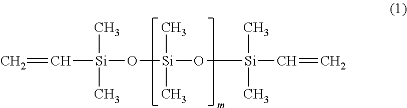

“m” represents a number such that the kinematic viscosity at 25° C. was 30,000 mm²/s.

Blending amount: 100 parts by mass

Component (b): Aluminum oxide powder having an average particle diameter of 1 μm in which an amount of coarse particles with 30 μm or more was 0.5 mass %

Blending amount: 510 parts by mass

Component (c): Methylhydrogenpolysiloxane having a hydrogen atom bonded to a silicon atom on the side chain, represented by the following average formula (2)

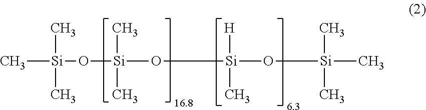

Blending amount: 1.7 parts by mass

Component (d): A solution of chloroplatinic acid at 5 mass % in 2-ethylhexanol

Blending amount: 1.0 part by mass

Component (e): A toluene solution of a silicone resin approximately composed of a (CH₃)₃SiO_{1/2} unit (an M unit) and a SiO_{4/2} unit (a Q unit) (the mole ratio of the M unit/the Q unit was 1.15) (non-volatile content: 70 mass %; kinematic viscosity at 25° C.: 30 mm²/s)

Blending amount: 175 parts by mass

Component (f): 3-Methyl-1-tridecyn-3-ol as an addition reaction controlling agent

Blending amount: 0.2 parts by mass

Component (g): Dimethylpolysiloxane having an average polymerization degree of 30 and blocked at one end with a trimethoxysilyl group, represented by the following formula (3)

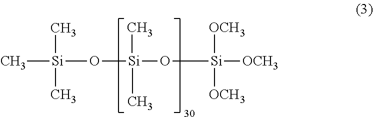

Blending amount: 14 parts by mass

The above adhesion layer B-2 was obtained by applying the silicone adhesive prepared as above by using a comma coater so that the thickness was as above on a separator on which a fluorine-modified silicone resin releasing agent has been applied, and heating for curing the adhesive at 80° C. for 3 minutes and then 120° C. for 5 minutes.

### [Method for Evaluating Adhesion Layer]

The thermal resistance of the adhesion layer was evaluated by the following method. The result is shown in Table 1.

The adhesion layer obtained as above with 12.7 mm in diameter was sandwiched between two aluminum plates with 12.7 mm in diameter and 1 mm in thickness, a pressure of 137.9 kPa (20 psi) was applied and the adhesion layer was left to stand at a room temperature (25° C.) for 60 minutes, and then the thermal resistance of the adhesion layer was measured with a thermal resistance measuring device (LFA447Nanoflash, available from NETZSCH Group) based on a laser flash method.

### [Method for Producing Heat Radiation Composite Film]

So that each of the structures shown in Table 1 was obtained, the above adhesion layer was laminated on the heat radiation layer in Example 1 and Example 3, or on one side of the substrate layer opposite to the heat radiation layer in Examples 2 and 4 and Comparative Examples 1 to 4. Each of the obtained laminates was subjected to a pressure of 0.5 MPa by using a laminator apparatus at a room temperature (25° C.) for 5 minutes to obtain each of heat radiation composite films of Examples 1 to 4 and Comparative Examples 1 to 4. Each of the obtained heat radiation composite films was subjected to a heat radiation test by the following evaluation method. The results are also shown in Table 1.

### [Method for Evaluating Heat Radiation Composite Film]

### Heat Radiation Test

The heat radiation composite film was adhered onto a top surface with 15 mm×15 mm and three side surfaces with 15 mm×10 mm of a heat source with 15 mm in width×15 mm in length×10 mm in height so that no air bubble entered and so that each of the surfaces was entirely covered with the heat radiation composite film. An electric power of 4 W was applied to the heat source, and a temperature on a surface of the heat source after 2 hours on which the heat radiation composite film was not adhered was measured. This was a test of expecting a case where an area of the heat dissipation film became equivalent to or smaller than an area of the heat source in practice. It should be noted that the measurement environment was 25° C. at a humidity of 50.

TABLE 1

| Structure of | | | | | | Comparative | Comparative | Comparative | Comparative |
|---|---|---|---|---|---|---|---|---|---|
| Heat Radiation Sheet | | Example 1 | Example 2 | Example 3 | Example 4 | Example 1 | Example 2 | Example 3 | Example 4 |
| Heat Radiation Layer | | A-1 | A-2 | A-1 | A-2 | A-3 | A-3 | A-4 | A-4 |
| and Substrate Layer | | | | | | | | | |
| Adhesive Layer | | B-1 | B-1 | B-2 | B-2 | B-1 | B-2 | B-1 | B-2 |
| Heat | Emissivity | 0.86 | 0.86 | 0.86 | 0.86 | 0.86 | 0.86 | 0.86 | 0.86 |
| Radiation | Developed Area Ratio | 1.7 | 1.7 | 1.7 | 1.7 | 1.2 | 1.2 | 1.0 | 1.0 |
| Layer | Thermal Conductivity | 0.1 | 0.1 | 0.1 | 0.1 | 0.1 | 0.1 | 0.1 | 0.1 |
| | in plane direction | | | | | | | | |
| Substrate | Thermal Conductivity | — | 236 | — | 236 | 236 | 236 | 236 | 236 |
| Layer | in plane direction | | | | | | | | |
| Adhesion | Thermal Resistance | 2.8 | 2.8 | 0.9 | 0.9 | 2.8 | 0.9 | 2.8 | 0.9 |
| Layer | (cm² · K/W) | | | | | | | | |

| | | | | | | | | |
|---|---|---|---|---|---|---|---|---|
| Result of | 57.8 | 57.6 | 57.4 | 57.6 | 59.0 | 59.2 | 59.7 | 59.4 |
| Heat Radiation Test (° C.) | | | | | | | | |

As shown in Table 1, in the heat radiation test, the temperature of the heat source was obviously lowered and effective heat radiation was found in Examples 1 to 4 with the developed area ratio of the heat radiation layer of 1.7, in contrast to Comparative Examples 3 and 4 in which the developed area ratio of the heat radiation layer was 1.0, regardless of the thermal conductivity of the substrate layer in the plane direction of the substrate layer and the thermal resistance of the adhesion layer as long as the emissivities of the heat radiation layers were equal to each other. In Comparative Examples 1 and 2 with the developed area ratio of the heat radiation layer of 1.2, a clear effect was not observed compared with Comparative Examples 3 and 4 with the developed area ratio of the heat radiation layer of 1.0. That is, it is found that, when the area of the heat radiation composite film is equal to or smaller than the area of the heat generator, the heat radiation composite film with the developed area ratio of the heat radiation layer of 1.5 or more is suitable for heat radiation regardless of the substrate layer and the adhesion layer as long as the emissivities of the heat radiation layer are equal to each other.

### INDUSTRIAL APPLICABILITY

The heat radiation composite film of the present invention is effective for lowering temperature of a heat generator and for dissipating heat dissipated from a heat generator outside a housing. For example, the heat radiation composite film is suitably used for electronic terminals such as smartphones and laptop computers, personal computer servers, etc.

The present description includes the following embodiments.

[1] A heat radiation composite film, comprising:
a heat radiation layer; and
an adhesion layer,
wherein the heat radiation layer has a thickness of 5 μm or more and 200 μm or less, and one surface of the heat radiation layer is a rough surface having an emissivity of 0.80 or more and having a developed area ratio of 1.5 or more, and
the adhesion layer is provided on a side of a surface of the heat radiation layer opposite to the rough surface.

[2] The heat radiation composite film according to [1], wherein the heat radiation layer comprises any one selected from the group consisting of a polyester resin, a fluororesin, an acrylic resin, an epoxy resin, a urethane resin, and a polyolefin resin.

[3] The heat radiation composite film according to [1] or [2], further comprising one or more of a substrate layer between the heat radiation layer and the adhesion layer, wherein the substrate layer comprises any one or more selected from the group consisting of a polyester resin, a fluororesin, an acrylic resin, an epoxy resin, a urethane resin, a polyolefin resin, a silicone resin, and a metal foil.

[4] The heat radiation composite film according to [3], wherein a total thickness of the heat radiation layer and the substrate layer is 30 μm or more and 200 μm or less, and a ratio of a thickness of the heat radiation layer to a thickness of the substrate layer is 0.02 or more and 39 or less.

[5] The heat radiation composite film according to [3] or [4], wherein the substrate layer is a metal foil having a thermal conductivity in a plane direction of 200 W/mK or more.

[6] The heat radiation composite film according to any one of [1] to [5], wherein the adhesion layer has a thermal resistance of 1.2 cm²·K/W or less.

[7] The heat radiation composite film according to any one of [1] to [6], wherein the adhesion layer comprises a thermal conductive filler.

[8] The heat radiation composite film according to any one of [1] to [7], wherein the adhesion layer is a cured product of a silicone composition comprising essential components of:
(a) 100 parts by mass of a linear organopolysiloxane having an alkenyl group;
(b) 300 to 900 parts by mass of a thermal conductive filler;
(c) an organohydrogenpolysiloxane at an amount so that a mole ratio of a hydrogen atom directly bonded to a silicon atom in the component (c) relative to the alkenyl group in the component (a) is 0.5 to 20; and
(d) a platinum-group metallic catalyst at 0.1 to 1,000 ppm of the component (a) in terms of a mass of a platinum-group metal element.

[9] The heat radiation composite film according to [8], wherein the silicone composition further comprises: (e) 50 to 300 parts by mass of a silicone resin having a branched chain structure.

It should be noted that the present invention is not limited to the above-described embodiments. The embodiments are just examples, and any examples that substantially have the same feature and demonstrate the same functions and effects as those in the technical concept disclosed in claims of the present invention are included in the technical scope of the present invention.

1-9. (canceled)

10. A heat radiation composite film, comprising:
a heat radiation layer; and
an adhesion layer,
wherein the heat radiation layer has a thickness of 5 μm or more and 200 μm or less, and one surface of the heat radiation layer is a rough surface having an emissivity of 0.80 or more and having a developed area ratio of 1.5 or more, and
the adhesion layer is provided on a side of a surface of the heat radiation layer opposite to the rough surface.

11. The heat radiation composite film according to claim 10, wherein the heat radiation layer comprises any one selected from the group consisting of a polyester resin, a fluororesin, an acrylic resin, an epoxy resin, a urethane resin, and a polyolefin resin.

12. The heat radiation composite film according to claim 10, further comprising one or more of a substrate layer between the heat radiation layer and the adhesion layer, wherein the substrate layer comprises any one or more selected from the group consisting of a polyester resin, a fluororesin, an acrylic resin, an epoxy resin, a urethane resin, a polyolefin resin, a silicone resin, and a metal foil.

13. The heat radiation composite film according to claim 11, further comprising one or more of a substrate layer between the heat radiation layer and the adhesion layer, wherein the substrate layer comprises any one or more selected from the group consisting of a polyester resin, a fluororesin, an acrylic resin, an epoxy resin, a urethane resin, a polyolefin resin, a silicone resin, and a metal foil.

14. The heat radiation composite film according to claim 12, wherein a total thickness of the heat radiation layer and the substrate layer is 30 μm or more and 200 μm or less, and a ratio of a thickness of the heat radiation layer to a thickness of the substrate layer is 0.02 or more and 39 or less.

15. The heat radiation composite film according to claim 13, wherein a total thickness of the heat radiation layer and the substrate layer is 30 μm or more and 200 μm or less, and a ratio of a thickness of the heat radiation layer to a thickness of the substrate layer is 0.02 or more and 39 or less.

16. The heat radiation composite film according to claim 12, wherein the substrate layer is a metal foil having a thermal conductivity in a plane direction of 200 W/mK or more.

17. The heat radiation composite film according to claim 10, wherein the adhesion layer has a thermal resistance of 1.2 cm²·K/W or less.

18. The heat radiation composite film according to claim 10, wherein the adhesion layer comprises a thermal conductive filler.

19. The heat radiation composite film according to claim 11, wherein the adhesion layer comprises a thermal conductive filler.

20. The heat radiation composite film according to claim 12, wherein the adhesion layer comprises a thermal conductive filler.

21. The heat radiation composite film according to claim 13, wherein the adhesion layer comprises a thermal conductive filler.

22. The heat radiation composite film according to claim 14, wherein the adhesion layer comprises a thermal conductive filler.

23. The heat radiation composite film according to claim 15, wherein the adhesion layer comprises a thermal conductive filler.

24. The heat radiation composite film according to claim 16, wherein the adhesion layer comprises a thermal conductive filler.

25. The heat radiation composite film according to claim 17, wherein the adhesion layer comprises a thermal conductive filler.

26. The heat radiation composite film according to claim 10, wherein the adhesion layer is a cured product of a silicone composition comprising essential components of:
(a) 100 parts by mass of a linear organopolysiloxane having an alkenyl group;
(b) 300 to 900 parts by mass of a thermal conductive filler;
(c) an organohydrogenpolysiloxane at an amount so that a mole ratio of a hydrogen atom directly bonded to a silicon atom in the component (c) relative to the alkenyl group in the component (a) is 0.5 to 20; and
(d) a platinum-group metallic catalyst at 0.1 to 1,000 ppm of the component (a) in terms of a mass of a platinum-group metal element.

27. The heat radiation composite film according to claim 26, wherein the silicone composition further comprises: (e) 50 to 300 parts by mass of a silicone resin having a branched chain structure.
